(19) United States
(12) Patent Application Publication
(10) Pub. No.: US 2015/0009658 A1
(43) Pub. Date: Jan. 8, 2015

(54) ILLUMINATOR, AKA STREET-LIGHTS

(71) Applicants: Melinda Cameron, Baker City, OR (US); Scott Bartholdson, Baker ciity, OR (US)

(72) Inventors: Melinda Cameron, Baker City, OR (US); Scott Bartholdson, Baker ciity, OR (US)

(21) Appl. No.: 14/376,231

(22) PCT Filed: Feb. 1, 2013
(86) PCT No.: PCT/US13/24241

§ 371 Date: Aug. 1, 2014

Related U.S. Application Data
(60) Provisional application No. 61/594,313, filed on Feb. 2, 2012.

(51) Int. Cl. F21L 4/08; F21V 21/08; F21L 4/04

(52) U.S. Cl. CPC F21L 4/08; F21L 4/04; F21V 21/08; F21L 2001/00
USPC 362/183

(57) ABSTRACT

The Illuminator comprises a valuable versatile tool, offering safety and security for all individuals from all walks of life. The personal, portable, hands-free, bright illumination device would serve well the members of the armed forces, fire-service personnel, and law enforcement. The Illuminator would enable tradespeople by making hands-free illumination practical and convenient for any job. The rechargeable and solar power aspects of the Illuminator make it ideal in natural disaster and other emergency situations; removing not only the need for disposable batteries, but conventional power for charging as well; delivering light to anyone, anywhere.

### CROSS-REFERENCE TO RELATED APPLICATIONS

This application claims priority to U.S. Provisional Application No. 61/594,313, entitled “Illuminator” and filed on Feb. 2, 2012, the disclosure of which is hereby incorporated in its entirety by reference herein.

### BACKGROUND OF THE INVENTION

The Illuminator, is a hands-free, portable, personal illumination device, made to be worn on the hand, arm, wrist, or any or all clothing including caps, hats, hoods, helmets, and shoes; as well as pet collars and leashes. It is a single unit that is rechargeable and can be easily and quickly changed from one medium to another by the user depending upon desired application. The Illuminator is also designed to denote emergency situations, and be bright for use in such as natural disasters, blackouts, car emergencies, and all work applications where ordinary flashlights would apply.

### FIELD OF THE INVENTION

The present invention relates generally to the field of illuminators and more specifically relates to illuminators that may be worn on the hand, arm, wrist, or any or all clothing including caps, hats, hoods, helmets, and shoes; as well as pet collars and leashes.

### DESCRIPTION OF THE RELATED ART

Everybody in all walks of life use lighting to illuminate their world; dark hours present difficulty and danger for societies and citizens. Ordinary flashlights are problematic due to their handling and holding, as well as their constant battery consumption. Other hands-free lighting is limiting and wasteful as well, though as bright are not rechargeable, lightweight, or solar compatible. It is desired that a reliable, portable, and efficient lighting means be developed for use.

Various attempts have been made to solve problems found in lighting means art. Among these are found in: U.S. Pat. No. 4,625, 339 to Peters; U.S. Pat. No. 6,892,397 to Raz; U.S. Pat. No. 7,152,248 to Ziemer; U.S. Pat. No. 7,152,248 to Rick L. Ziemer; U.S. Pat. No. 5,345,368 to Thomas L. Huff; and U.S. Pub. No. 2001/0048596 to Daniel G. Kerr. This prior art is representative of illuminators.

None of the above inventions and patents, taken either singly or in combination, is seen to describe the invention as claimed. Thus, a need exists for a reliable versatile hand/arm/wrist/cap/hat/hood/helmet/shoes/pet collars/leashes or any clothing-worn or pet used illuminator to avoid the above-mentioned problems.

### BRIEF SUMMARY OF THE INVENTION

In view of the foregoing disadvantages inherent in the known illuminator art, the present invention provides a novel versatile illuminator to be worn on the hand, arm, wrist, or any or all clothing including caps, hats, hoods, helmets, and shoes; as well as pet collars and leashes. The general purpose of the present invention, which will be described subsequently in greater detail, is to provide efficient and effective illumination means for user-wearers. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, Illuminator, constructed and operative according to the teachings of the present invention.

FIG. 1 shows a top perspective view illustrating an Illuminator in an in-use condition according to an embodiment of the present invention.

FIG. 2 is a bottom perspective view illustrating the Illuminator according to an embodiment of the present invention.

FIG. 3 is an exploded view illustrating the Illuminator according to an embodiment of the present invention.

FIG. 4 is a perspective view illustrating the Illuminator on a baseball cap according to an embodiment of the present invention.

FIG. 5 is a perspective view illustrating the Illuminator with a stretchable arm band according to an embodiment of the present invention.

FIG. 6 is a perspective view illustrating the Illuminator on a shirt front according to an embodiment of the present invention.

FIG. 7 is a perspective view illustrating the Illuminator on a shirt sleeve according to an embodiment of the present invention.

FIG. 8 is a perspective view illustrating the Illuminator on a pocket according to an embodiment of the present invention.

The various embodiments of the present invention will hereinafter be described in conjunction with the appended drawings.

### DETAILED DESCRIPTION OF THE INVENTION

As discussed above, embodiments of the present invention relate to a lighting device and more particularly to a versatile Illuminator worn on the hand, arm, wrist, or any or all clothing including caps, hats, hoods, helmets, and shoes; as well as pet collars and leashes, as used to improve the efficiency and effectiveness of lighting.

The present invention provides personal illumination that is bright and lightweight that can be used by pedestrians, bike riders, skate boarders, dog walkers, joggers, and all outdoor enthusiasts alike. The device may be used by law-enforcement, rescue, security, and armed forces personnel; mechanics; construction-trades personnel; and household consumers with an effective source of illumination, and at the same time free both their hands for the performance of a wide variety of tasks.

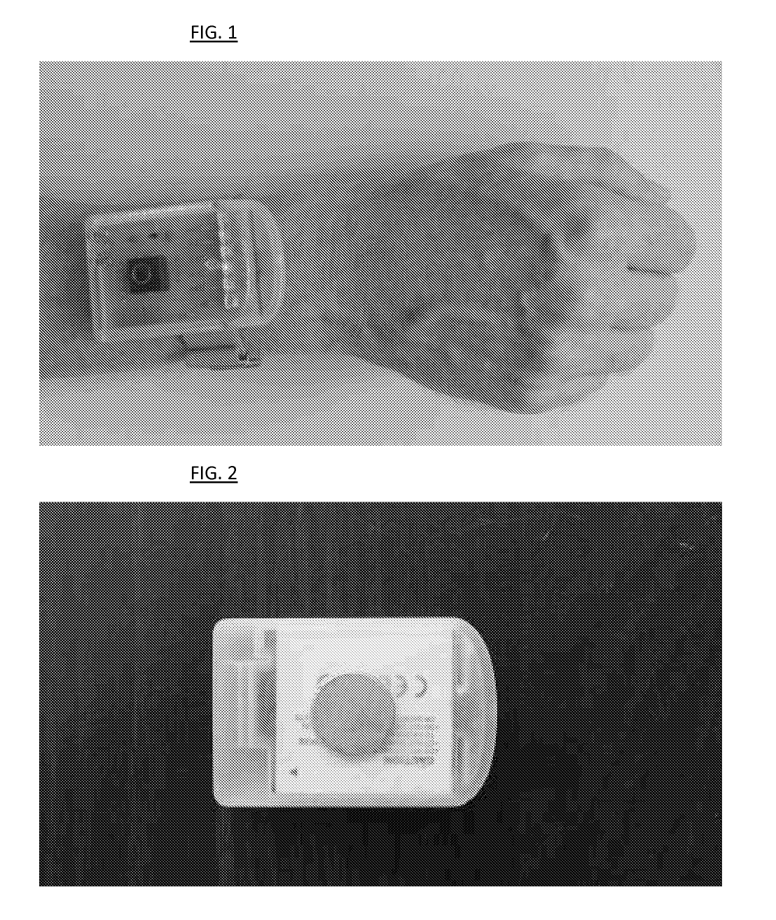

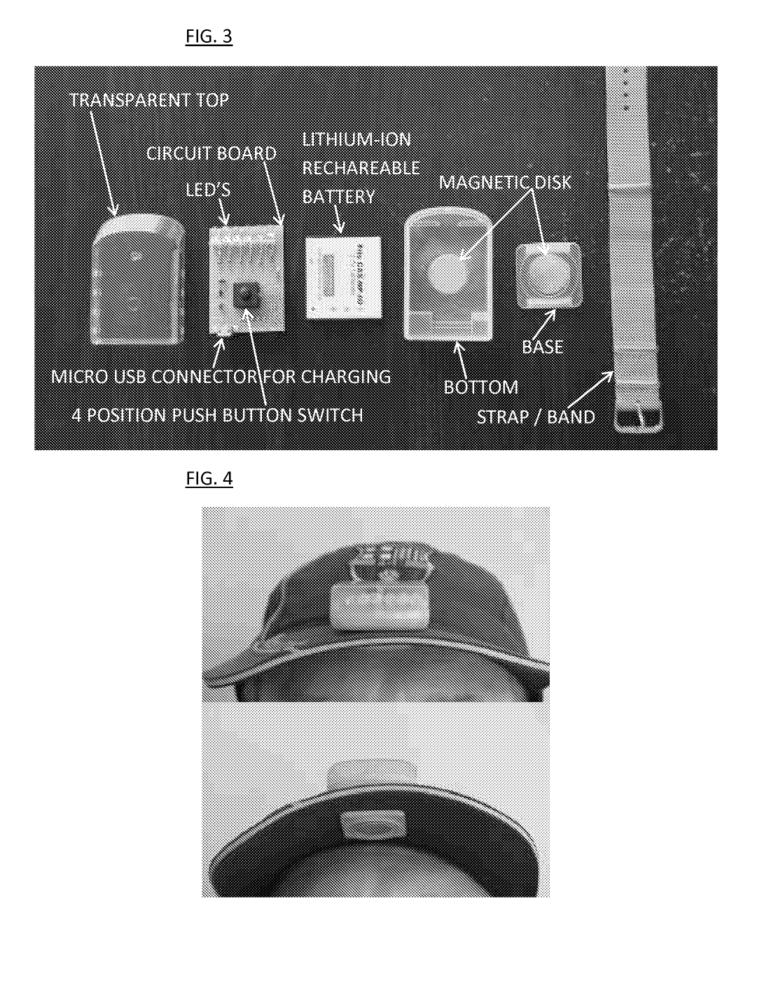

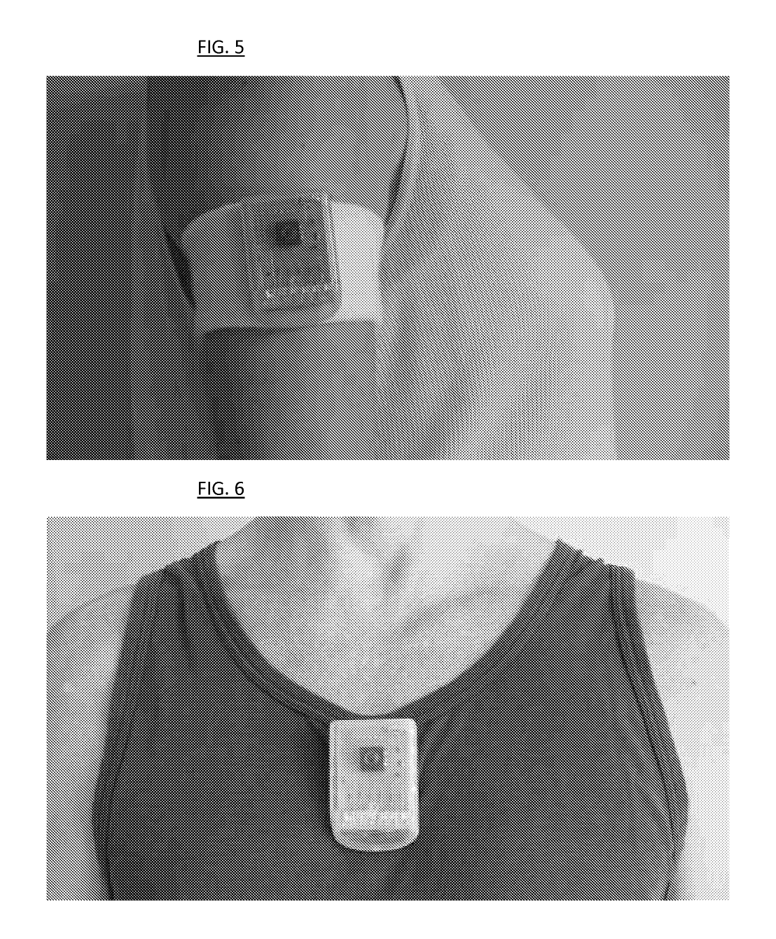

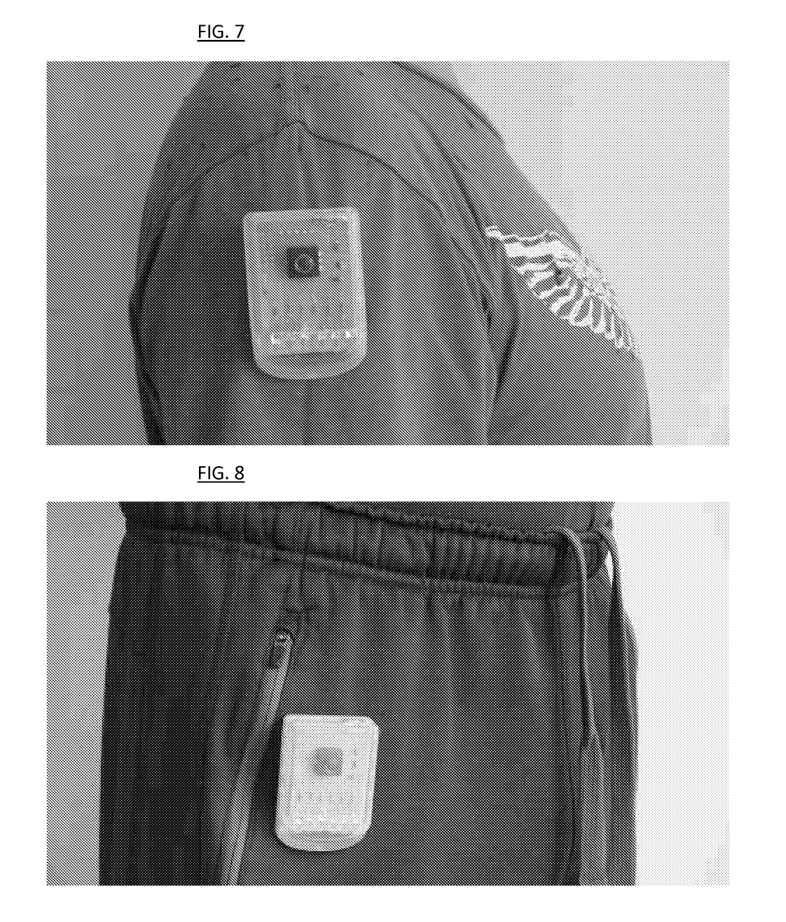

Referring now to the drawings FIGS. 1-8, the Illuminator comprises a valuable tool for rescue and fire-service personnel, members of the armed services, and law-enforcement officers, as mentioned previously. Further, the Illuminator would extend equally to do-it-yourself householders, construction workers in a variety of trades, professional mechanics, and virtually anyone else who perform tasks requiring manual dexterity in a dimly lit place or at night.

The streamlined Illuminator comprises LED's and electronic components (power supply, 4 position push-button switch) which are built into the Illuminator. In this version, the Illuminator would employ one or more, bright LED's, able to focus and aim light in virtually any direction, utilizing the 360 degree rotatable magnetic base, as well as produce a flashing distress signal. These lights would be powered by a compact, rechargeable lithium-ion battery.

A rubberized or rubber-coated, waterproof, 4 position push-button (on/off, high/low beam, distress signal) switch may be used. Adjacent to the battery compartment is a small, hatch covered charging port, with either a hole-and-post or USB connection. Preferably, the Illuminator retail package would include a standard household adapter-and-charger; a solar charger; or a plug-in charger for use with a motor vehicle's cigarette lighter or auxiliary power-port.

The Illuminator might be produced in a variety of colors, including phosphorescent, and textures to enhance camouflage or gripping capabilities; and it might also be produced in a two-tone, high-contrast, high-visibility version (perhaps more appropriate for search-and-rescue workers, for example). The LED's provide ample, wide-angle illumination for the wearer and the Illuminator's LED's, of course, would be visible to others from great distances.

The Illuminator as such will provide a bright, lightweight, low profile, cutting edge flashlight technology. One or more white or other color LED's produce light for a bright broad-beam projection or flashing distress signal-perfect for tradesman, power outages, emergencies, household tasks, outdoor night-time activities, search and rescue, military, mechanics, police and fire departments and anyone who wants an easier way to get around in dark hard to see areas, making the Illuminator ideal for personal portable illumination.

As may be seen from the foregoing description, the Illuminator presents users with a literal “handy” source of ample, long-lasting illumination—and does so while leaving the user's hands free to perform their work, hold and manipulate tools, and so forth. Ruggedly designed to resist shock, weather, and wear, the Illuminator has been conceived to aid those working in dimly lit or dark hazardous environments, where both light and manual dexterity are at a premium; the Illuminator would provide that illumination and facilitate that dexterity.

Lightweight and versatile, impervious to water and temperature extremes, the Illuminator is also able to be quickly rechargeable through a standard household outlet, solar charger, or an automotive auxiliary power-port; with an easy-to-operate push-button switch for bright light instantly. This device with an ergonomic combination of comfort, technology, and efficiency provides an environmentally friendly hands-free illuminating experience. It would serve front-line workers ranging from military and law-enforcement personnel to firefighters and paramedics, as well as serving the needs of householders looking for lost items in dark storage sheds, or searching the dark of a car engine for a dropped bolt, making it multi-functional in a variety of applications. The device may be used by pedestrians, bike riders, skate boarders, dog walkers, joggers, and all outdoor enthusiasts alike for safety and security.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office, and the World Intellectual Property Organization and the public generally, and especially the scientist, engineers and practitioners in the art who are not familiar with patent or legal terms of phraseology, to determine quickly from a cursory inspection the nature and essence of the technical disclosure of the application.

What is claimed is:

1. The Illuminator is a bright, rechargeable, portable, personal, hands-free illumination device which is designed to be a wearable technology; worn on the hand, arm, wrist, or any or all clothing including caps, hats, hoods, helmets, and shoes; as well as pet collars and leashes, to provide convenient illumination in any or all situations that might require a light source.

2. A bright, rechargeable, portable, personal, hands-free illumination device as in claim 1, wherein the Illuminator is a self-contained, rechargeable light source containing one or more white or other color LED's producing light for a bright broad-beam projection or flashing distress signal, powered by a Lithium-ion battery and designed to be rechargeable for everyday use.

3. A bright, rechargeable, portable, personal, hands-free illumination device as in claim 2, wherein the Lithium-ion battery can be charged via house adapter, car adapter, or solar powered charger, depending on application and desired use.

4. A bright, rechargeable, portable, personal, hands-free illumination device as in claim 3, wherein the plastic top can be clear or transparent colors, and the plastic bottom containing a magnetic disk, comprise the housing of the Illuminator.

5. A bright, rechargeable, portable, personal, hands-free illumination device as in claim 4, wherein the base containing a magnetic disk is separable from the Illuminator for multiple user/wearer options, providing hands-free illumination in any situation.

6. A bright, rechargeable, portable, personal, hands-free illumination device as in claim 5, wherein the magnetic Illuminator housing rotates 360 degrees inside of magnetic base for directing the light wherever the user/wearer requires.
